(19) United States
(12) Patent Application Publication
(10) Pub. No.: US 2005/0199645 A1
(43) Pub. Date: Sep. 15, 2005

(54) Device for recognising containers

(76) Inventors: Ronald Sivertsen, Asker (NO); Mats Carlin, Gjettum (NO); Britta Greenberg Fismen, Oslo (NO); Ib-Rune Johansen, Oslo (NO)

Correspondence Address: RODMAN RODMAN, 7 SOUTH BROADWAY, WHITE PLAINS, NY, 10601, US

(21) Appl. No.: 10/519,309

(22) PCT Filed: Jun. 25, 2003
(86) PCT No.: PCT/NO03/00212

§ 371 Date: May 2, 2005

(30) Foreign Application Priority Data
Jun. 26, 2002 (NO) 20023090

(51) Int. Cl. B65H 3/28; G07F 11/16

(52) U.S. Cl. 221/221

(57) ABSTRACT

A device for recognising a container by means of a marking provided on its surface, comprising a camera and light emission means (1, 2, 3) arranged for imaging the marking (4) on the container (5). The means is connected to a processor adapted for recognition, based on a camera-recorded image of the marking, of distinctive features related to the container. To ensure that the image has the quality required for recognition of the container, the means consists of one camera (1) and two light sources (2, 3), the said light sources being positioned in such manner, either on the same or on each side of the camera, that light emitted from the respective light sources falls in from a different direction relative to the marking, thereby allowing the camera to take two images of the marking using light emitted successively from the respective light source. Alternatively, the means may consists of two cameras and one light source, the cameras being positioned in such manner, either on the same or on each side of the light source, that the optical axis of the respective camera falls in from a different direction relative to the marking, so that the cameras can take two images of the marking simultaneously. In yet another alternative, just one camera and one light source are used, wherein the camera is pointed towards an assembly of mirror faces which in pairs are positioned relative to one another in such manner that the camera is able simultaneously to take two mirror images from different directions in the mirror faces adjacent to the optical axis of the camera.

The present invention relates to a device for recognising a container, and in particular to a device for recognising distinctive features related to the container by means of a camera-recorded image of a marking provided on its surface.

There are a number of different types of devices for recognising a container based on various distinctive features related to the container such as its shape, bar code and material, especially in connection with reverse vending machines for beverage containers. In general, such devices function satisfactorily, provided that the container has the expected property, thereby allowing non-returnable containers to be rejected. However, practice shows that this is not sufficient to prevent non-returnable containers from being accepted during the recognition process, as it is possible to beat systems of this type, for example, by attaching a bogus bar code to the container.

In view of this, it has therefore been suggested, as an additional precaution, that each container should be provided with an extra marking in the form of one or more surface irregularities which extend outwards or inwards, and which mean that the surface of the container is not flat in the area of the marking. Recognition of containers that are marked in this way can be effected, as taught in U.S. Pat. No. 5,693,017, by using a camera-recorded image of the marking, i.e., using a camera and light emission means that is directed towards the embossment, and which is connected to a processor suitably equipped for recognition of the container.

Normally the containers are made by cold processing aluminium, for example, by rolling the end face with the pouring opening and deep drawing the actual container body. Such cold processing, by both rolling and deep drawing, results in the formation of minute flaws in the surface of the aluminium parallel to the rolling or drawing direction. These flaws have not caused any disadvantages in connection with conventional container recognition, but it has been found, however, that they cause unexpected problems during camera-recorded imaging of the marking on the container surface. More specifically, the problem concerned consists of specular reflection along the length of the flaws and diffuse reflection transverse to the flaws. The consequence of these reflections is that the image often does not have the quality, i.e. the sharpness, that the processor requires for container recognition. Moreover, tests have confirmed that the problem is just as great no matter how far the marking extends from the container surface. Consequently, an undesirably large number of the containers are rejected during the recognition process as a result of the flaws caused by the cold processing.

Accordingly, the object of the present invention is to eliminate the problems mentioned above in connection with the flaws in the container surface, and thus provide a device for recognising a container, in which the image has the quality required for reliable recognition of the container with a minimum of rejections.

According to one aspect, the present invention provides a device for recognising a container by means of a marking provided on its surface, comprising a camera and light emission means arranged for imaging the marking on the container, wherein the camera and light emission means is connected to a processor or the like adapted for recognition, based on a camera-recorded image of the marking, of distinctive features related to the container, and wherein the camera and light emission means faces the marking during the imaging process, characterised in that the camera and light emission means consists of one camera and at least two light sources, said light sources being positioned in such manner, either on the same side or on each side of the camera, that light emitted by the respective light sources falls in from a different direction relative to the marking, and that the camera and light emission means is controlled in such manner by the processor that the camera can take at least two images of the marking using the light emitted successively from the respective light source or the selectively chosen light source group.

Thus, the camera can take at least two images using light that falls in from a different direction relative to the markings, so that at least one of these images has the image quality required for recognition of the container.

According to a second aspect, the present invention provides a device for recognising a container by means of a marking provided on its surface, comprising a camera and light emission means arranged for imaging the marking on the container, wherein the camera and light emission means is connected to a processor or the like adapted for recognition, based on a camera-recorded image of the marking, of distinctive features related to the container, and wherein the camera and light emission means faces the marking during the imaging process, characterised in that the camera and light emission means consists of at least two cameras and one light source, said cameras being positioned in such manner, either on the same side or on each side of the light source, that the optical axis of the respective camera falls in a different direction relative to the marking, and that the camera and light emission means is controlled in such manner by the processor that the cameras or the selectively chosen camera group can take at least two images of the marking simultaneously.

Thus, the camera can take at least two images simultaneously with the respective optical axis falling in a different direction relative to the marking so that at least one of these has the image quality that assures recognition of the container. The operating speed is also increased since the images are taken simultaneously by the cameras.

According to yet another aspect, the present invention provides a device for recognising a container by means of a marking provided on its surface, comprising a camera and light emission means consisting of one camera and at least one light source, and which is arranged for imaging the marking on the container, wherein the camera and light emission means is connected to a processor or the like adapted for recognition, based on a camera-recorded image, of distinctive features related to the container, characterised by an assembly of mirror faces which in pairs are positioned relative to one another in such manner that the camera can take two images of the marking simultaneously, the said mirror faces in respective pairs being positioned on the same side of the optical axis of the camera and facing each other, with one of the mirror faces adjacent to the optical axis, and that the camera during the imaging process is pointed towards the mirror faces adjacent to the optical axis, in which the marking is shown as two mirror images seen from different directions.

Thus, the camera is able simultaneously to take two images of the marking seen from different directions, which images consist of the mirror images of the markings that are shown on the mirror faces adjacent to the optical axis of the camera. In addition, only one camera is required and the operating speed is reduced as a result of the simultaneous imaging.

Other advantageous features and aspects of the present invention will be understood from the dependent claims and the description.

The invention will now be explained in more detail with reference to the attached drawings and with the aid of exemplary embodiments, in which the present device is an integral part of a reverse vending machine for beverage containers.

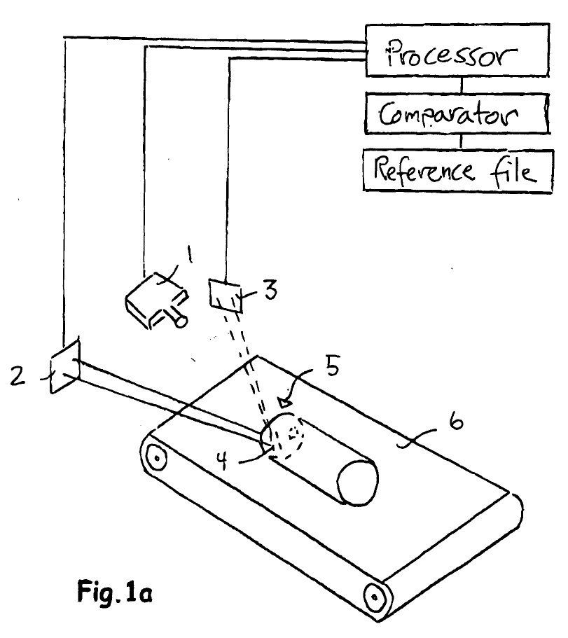

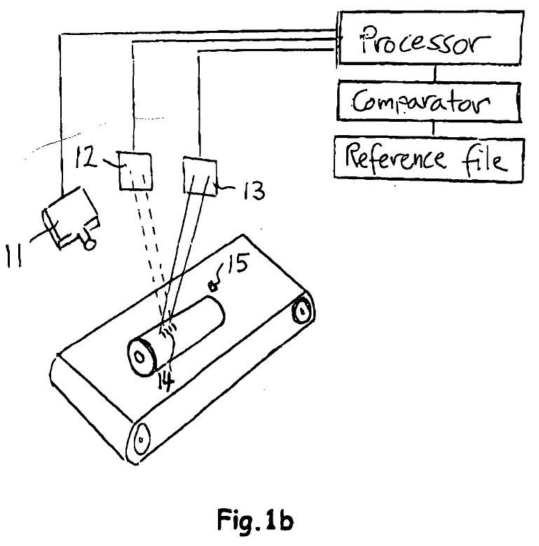

FIG. 1a is a schematic perspective view of an embodiment of the present device arranged in connection with the conveyor of a reverse vending machine, comprising a camera and light emission means consisting of one camera and two light sources placed on either side of the camera, wherein means is arranged for imaging a marking provided in the end face of the container and is controlled in such manner by a processor that the camera can image the marking using light successively emitted from the light sources.

FIG. 1b is a schematic perspective view of a second embodiment of the present device corresponding to FIG. 1a, except that the marking is provided on the side face of the container and the two light sources are placed on the same side of the camera.

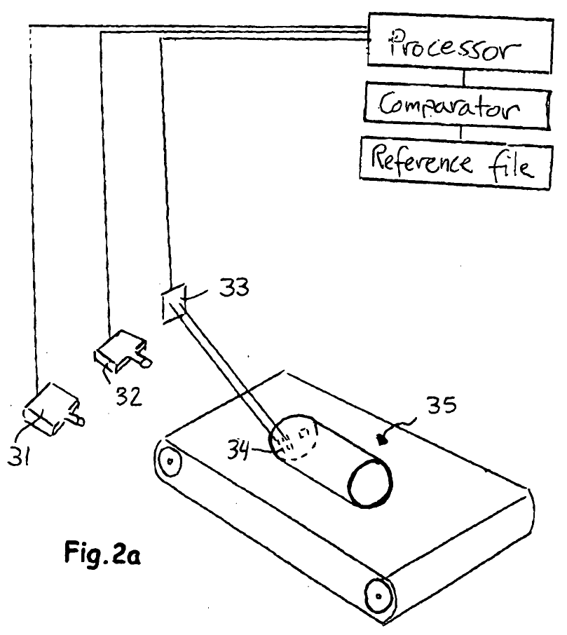

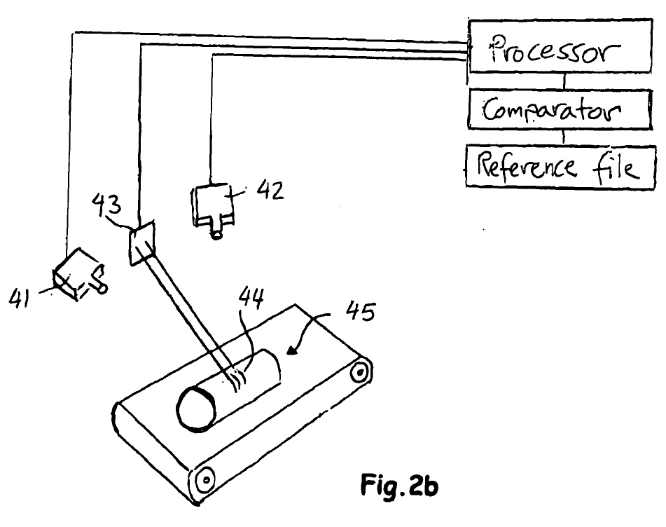

FIG. 2a is a schematic perspective view of yet another embodiment of the present device corresponding to FIG. 1a, except that the camera and light emission means consists of two cameras that are placed on the same side of one light source and is controlled in such manner that the cameras can image the marking simultaneously.

FIG. 2b is a schematic perspective view of still another embodiment of the present device corresponding to FIG. 2a, except that the marking is provided on the side face of the container and the two cameras are placed on either side of the light source.

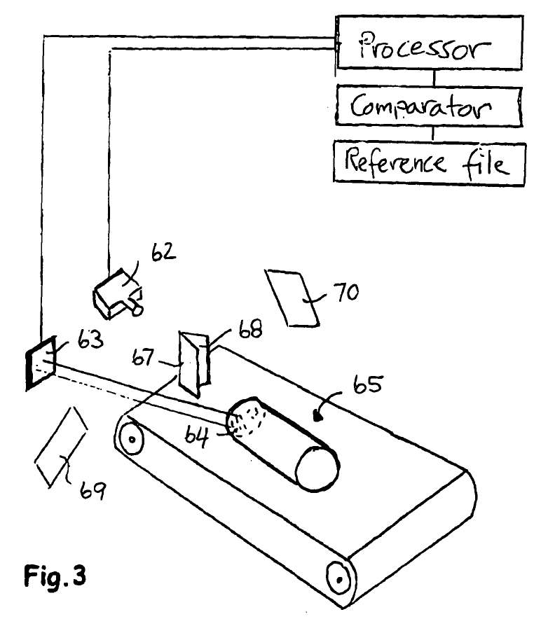

FIG. 3 is a schematic perspective view of yet another embodiment of the present device, in which the camera and light emission means consists of one camera and one light source, wherein the camera is directed towards an assembly of mirror faces which in pairs are positioned relative to one another in such manner that the camera is able simultaneously to take two images of the marking that is shown in the two mirror faces adjacent to the optical axis of the camera.

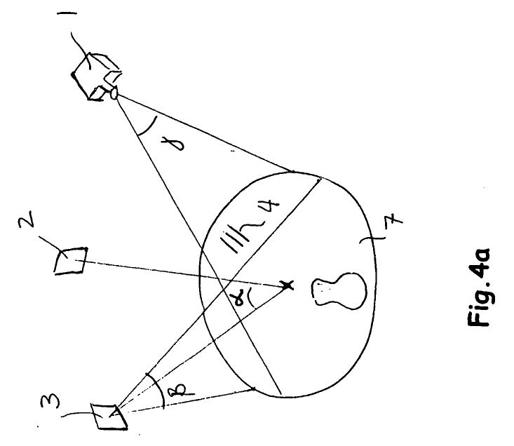

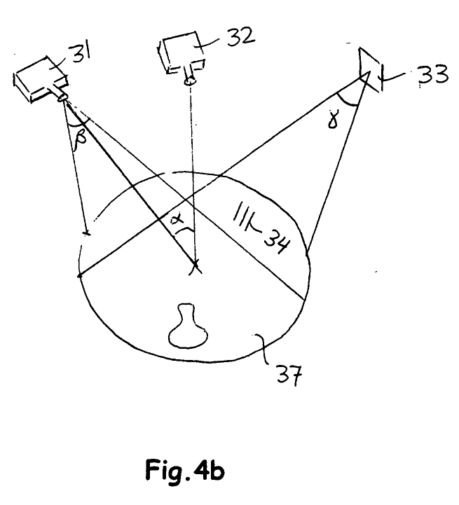

FIG. 4a shows by means of a schematic section of an embodiment of the present device, in which the marking is on the end face of the container and when one camera and two light sources are used, the three angles formed between the two lines drawn respectively from the centre point of the end face to the centre point of each light source, from the centre point of the outer light source to the outer edges of the end face along the respective diameter and from the centre point of the camera lens to the outer edges of the end face along the respective diameter.

FIG. 4b shows by means of a schematic section of an embodiment of the present device, in which the marking is on the end face of the container and when two cameras and one light source are used, the three angles formed between the two lines drawn respectively from the centre point of the end face to the centre point of each camera, from the centre point of the outer camera to the outer edges of the end face along the respective diameter and from the centre point of the light source to the outer edges of the end face along the respective diameter.

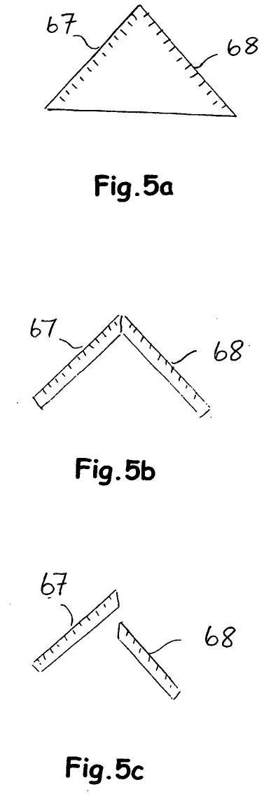

FIGS. 5a-c show in cross section different embodiments of the mirror faces adjacent to the optical axis of the camera.

Although in the discussion of the drawings it is mentioned that the present device is a part of a reverse vending machine for beverage containers, it should be noted that the invention is not limited to either reverse vending machines or to beverage containers. Consequently, the device according to the invention could be included in a structure, e.g., a sorting plant, where it is appropriate to recognise containers based on a camera-recorded image of the marking thereon. Similarly, the containers may be filled with or have contained any suitable medium.

Moreover, it should be noted that known reverse vending machines may be constructed in different ways depending upon the specifications regarding their operation. For the sake of simplicity, the present set of figures therefore shows only the components that are necessary for the understanding of the actual invention, i.e., the present camera and, light emission means, the mirror assembly, the associated processor with comparator and reference archive, and the conveyor of the reverse vending machine. The present device for recognising containers, based on a camera-recorded image of the marking provided on the surface of the container, may thus constitute a supplementary element in a reverse vending machine which has, for example, conventional equipment for recognition by means of the shape, bar code and material of the container. Such conventional recognition equipment could also in some cases be replaced by the device according to the invention.

The conveyors that are illustrated schematically in the drawings are of any type used in such reverse vending machines, for example, of the type able to rotate the container about its longitudinal axis into the right position relative to the equipment for recognition of the bar code etc. In that case, the conveyor may consist of two conveyor belts so positioned that they form a V-shape in cross section, and which are drawn apart to bring the container into contact with subjacent rollers for rotation about its longitudinal axis.

The schematically illustrated processors are of any commonly used type. The processors are adapted to control the operation of the camera and light emission means that are components of the different embodiments of the present device, and preferably comprise a comparator and a reference archive. During the container recognition procedure, the processor selects the image that the comparator is to compare with the reference archive, so that distinctive features related to the container can thus be recognised.

As shown in FIGS. 1a-1b, the device for recognising containers comprises, according to a first aspect of the invention, a camera and light emission means 1, 2, 3 or 11, 12, 13 arranged for imaging a marking 4 or 14 provided either on the end face or the side face of the container 5 or 15. This means is connected to a suitable processor or the like and is positioned in such manner that when the container is on a conveyor 6 or 16, as shown, the marking faces it.

In order at least to produce one image of the marking that is sharp enough for use during recognition of the container by the processor equipped with the comparator and the reference archive, the means mentioned above consists of one camera 1 or 11, and two light sources 2, 3 or 12, 13 that are positioned either on each side of or on the same side of the camera. In the embodiments shown in FIGS. 1a-b, the light sources are placed on either side and on the same side of the camera, respectively. Alternatively, the light sources in both these cases may be placed (not shown) on the same side or on either side of the camera. It is also possible to use more than two light sources (not shown), which are then grouped as desired relative to the camera, so that more than two images of the marking can be taken, if so desired.

According to a second aspect of the present invention, the camera and light emission means, as shown in FIGS. 2a-b, has two cameras 31, 32 or 41, 42 placed on the same side or on each side of one light source 33 or 43. It is also possible to use more than two cameras (not shown), which are grouped as desired relative to the light source, so that more than two images can be taken as required. In this case, the processor is controlled in such manner by the processor that the marking 34 or 44 is imaged simultaneously by the cameras, or selectively chosen groups if more than two cameras are used, i.e., the light source can emit light that is synchronised with a respective camera or group of cameras. In the respective cases, unlike the embodiments shown in FIGS. 2a-b, the cameras may be placed on the same side or on each side of the light source (not shown).

As shown in FIGS. 1a-b, the camera 1 or 11 is preferably positioned above the conveyor 6 or 16, with the camera positioned in such manner that the optical axis falls essentially perpendicular to the marking 4 or 14. Similarly, the light source 33 or 43, as shown in FIGS. 2a-b, is preferably positioned above the conveyor 36 or 46, with the light source positioned in such manner that emitted light falls essentially perpendicular to the marking 34 or 44.

If using, as shown in FIG. 4a, a marking on the end face 7 of the container and light sources 2, 3 positioned on the same side of the camera 1, the interpositioning should be such that fulfils the expression:
α≧β+γ, wherein
α is the angle between the two lines drawn from the centre point of the end face of the container to the centre point of each light source;
β is the angle between the two lines drawn from the centre point of the outer light source to the outer edges of the end face of the container along the respective diameter; and
γ is the angle between the two lines drawn from the centre point of the camera lens to each outer edge of the end face of the container along the respective diameter.

When using a marking on the end face 37 of the container and two cameras 31, 32 placed on the same side of the light source, the interpositioning, as shown in FIG. 4b, ought to be such that it fulfils the expression:
α≧β+γ, wherein
α is the angle between the two lines drawn from the centre point of the end face of the container to the centre point of each camera;
β is the angle between the two lines drawn from the centre point of the outer camera lens to the outer edges of the end face of the container along the respective diameter; and
γ is the angle between the two lines drawn from the centre point of the light source to each outer edge of the end face of the container along the respective diameter.

The camera and light emission means is in accordance with a third aspect of the invention limited to just one camera 62 and at least one light source 63. However, as shown in FIG. 3, it is required that an assembly of mirror faces 67, 68, 69, 70 be used, which in pairs are positioned relative to each other in such manner that the camera can simultaneously take two images of the marking 64 on the surface of the container 65, and also that the mirror faces in respective pairs are placed on the same side of the optical axis of the camera and facing each other, with one of the mirror faces 67, 68 adjacent to the optical axis. Thus, the simultaneous imaging consists of the two mirror images of the marking that are shown on the mirror faces adjacent to the optical axis, and which are seen from different directions.

In this case, the camera 62 is directed towards the mirror faces adjacent to the optical axis. The light source 63, however, is directed towards the marking 64 on the surface of the container 65, and may be placed on the desired side of the camera. FIG. 3 shows the use of a single light source which covers the whole marking. However, it will be understood that several light sources having, for example, different light intensity, can be used, and that the positioning can differ from that shown. If, unlike the embodiment shown in FIG. 3, the marking is located on the side face of the container, the assembly of mirror faces 67, 68, 69, 70 must be placed longitudinally relative to the longitudinal axis of the container, with corresponding relocation of the camera and the light source.

The size of the mirror faces 67, 68, 69 and 70 in the respective pairs depends upon the distance between the marking 64 and the camera 62, and must be selected so that the whole field of view is covered. The angular position of the mirror faces relative to each other in the respective pairs is determined by the level at which the mirror faces are placed relative to the marking 64. Furthermore, the mirror faces 67, 68 adjacent to the optical axis of the camera are symmetrically placed and face in the opposite direction to each other. Preferably, the line of intersection between the mirror faces 67, 68 adjacent to the optical axis of the camera is essentially at right angles to the optical axis and is parallel to the end face bearing the marking 64. This is not a condition for the mirrors as such, as it will be appreciated that these must be angled in a desired manner in order to enable the camera to image the marking with the aid of the mirror face pairs.

Preferred embodiments of the mirror faces 67, 68 adjacent to the optical axis of the camera are shown in FIGS. 5a-c. Thus, the mirror faces may consist of a triangular prism body, of which the two sides facing the camera are mirror-coated, or of two square, mirror-coated plates. In the last-mentioned case, the side edge of the plates adjacent to the optical axis is bevelled, and is either positioned so that the two bevelled side edges meet or has the plates offset relative to each other along the optical axis. With an embodiment of the mirror faces adjacent to the optical axis as shown in FIGS. 5a-b, the centre point of the mirror faces will lie substantially along a straight line. However, in the embodiment shown in FIG. 5c, the centre point of the mirror faces in the respective pairs will lie along respective straight lines that are parallel to each other.

The marking on the container may have any suitable design. Typical examples are lo embossed patterns, impressed patterns, ridges etc extending outwards or inwards relative to the container surface, bar codes, texts, symbols, Braille and colouring agents applied externally on the container.

The light emitted by the respective light sources is of any suitable type, preferably short-pulsed light. The light sources may consist of at least one light-emitting diode. It should also be added that the cameras mentioned above are of any type within this field, for example, a CCD camera.

1. A device for recognising a container by means of a marking provided on its surface, comprising a camera and light emission means (1, 2, 3; 11, 12, 13) arranged for imaging the marking (4; 14) on the container (5; 15), said camera and light emission means being connected to a processor or the like adapted for recognition, based on a camera-recorded image of the marking, of distinctive features related to the container, and wherein the camera and light emission means faces the marking during the imaging process, where the camera and light emission means comprise one camera (1; 11) and at least two light sources (2, 3; 12, 13), the light sources being positioned in such manner, either on the same or on each side of the camera, that light emitted from the respective light source falls in from a different direction relative to the marking, and that the camera and light emission means is so controlled by the processor that the camera can take at least two images of the marking using light emitted successively from the respective light source or the selectively chosen light source group, said device being characterized in that when the marking (4) is provided in an end face of the container (5), then the camera (1) and the light sources (2, 3) are interpositioned so as to fulfil the expression:
α≧β+γ, wherein
α is the angle between the two lines drawn from the centre point of the end face on of the container to the centre point of each light source;
β is the angle between the line drawn from the centre point of the outer light source to the outer edges of the end faces of the container along the respective diameter; and
γ is the angle between the two lines drawn from the centre point of the camera lens to each outer edge of the container along the respective diameter.

2. A device for recognising a container by means of a marking provided on its surface, comprising a camera and light emission means (31, 32, 33; 41, 42, 43) arranged for imaging the marking (34; 44) on the container (35; 45), said camera and light emission means being connected to a processor or the like adapted for recognition, based on a camera-recorded image of the marking, of distinctive features related to the container, and wherein the camera and light emission means faces the marking during the imaging process, where the camera and light emission means consists of at least two cameras (31, 32; 41, 42) and one light source (33; 43), the cameras being positioned in such manner, either on the same or on each side of the light source, that the optical axis of the respective camera falls in from a different direction relative to the marking, and that the camera and light emission means is so controlled by the processor that the cameras or the selectively chosen camera group can take at least two images of the marking simultaneously, said device being characterised in that when the marking (34) is provided in an end face of the container (35), the cameras (31, 32) and the light source (33) are interpositioned so as to fulfil the expression:
α≧β+γ, wherein
α is the angle between the two lines drawn from the centre point of the end face of the container to the centre point of each camera;
β is the angle between the line drawn from the centre point of the outer camera lens to the outer edges of the end face of the container along the respective diameter; and
γ is the angle between the two lines drawn from the centre point of the light source to each outer edge of the container along the respective diameter.

3. A device for recognising a container by means of a marking provided on its surface, comprising a camera and light emission means consisting of one camera (62) and at least one light source (63), and which is arranged for imaging the marking (64) on the container (65), said 5 camera and light emission means being connected to a processor or the like adapted for recognition, based on a camera-recorded image of the marking, of distinctive features related to the container, characterised by at least a first pair (67, 69) and a second pair (68, 70) of mirrors, where the mirrors in each pair are facing one another and where the pairs are 10 positioned on opposite sides of the optical axis of said camera (62), one mirror (67) of the first pair being fixedly positioned adjacent to one mirror (68) of the second pair, at an angle to said axis, whereby the marking is shown as two mirror images seen from different directions and the camera is able to take two images of the marking (64) simultaneously.

4. A device according to claim 1, characterised in that the camera (1; 11), or the light source (33; 43) is placed at a level above the container (5; 15; 35; 45).

5. A device according to claim 1, characterised in that the respective light sources (2, 3) emit light that is synchronised with the exposures of the camera (1).

6. A device according to claim 2, characterised in that the light source (33) emits light that is synchronised with the exposure of the respective cameras (31, 32).

7. A device according to claim 1, characterised in that the light is short-pulsed light.

8. A device according to claim 1, characterised in that the light source (2, 3; 33) consists of at least one light-emitting diode.

9. A device according to claim 3, characterised in that the line of intersection between the mirror faces (67, 68) adjacent to the optical axis of the camera is essentially perpendicular to the optical axis, these mirror faces being symmetrically positioned and directed in the opposite direction to each other.

10. A device according to claim 9, characterised in that the mirror faces adjacent to the optical axis of the camera are so positioned that one of their sides edges meet.

11. A device according to claim 9, characterised in that the mirror faces adjacent to the optical axis of the camera are offset relative to each other along the optical axis.

12. A device according to claim 1, characterised in that the imaging is performed when the container (5; 35; 65) is on a conveyor (6; 36; 66) installed in a reverse vending machine for beverage containers.

13. A device according to claim 1, characterised in that the processor comprises a comparator designed for recognition, based on the image selected by the processor, of the marking on the container (5; 35; 65) by comparing with a reference archive of markings and thus recognising distinctive features related to the container.

14. A device according to claim 2, characterised in that the camera (1; 11), or the light source (33; 43) is placed at a level above the container (5; 15; 35; 45).

15. A device according to claim 2, characterised in that the light is short-pulsed light.

16. A device according to claim 3, characterised in that the light is short-pulsed light.

17. A device according to claim 2, characterised in that the light source (2, 3; 33) consists of at least one light-emitting diode.

18. A device according to claim 3, characterised in that the light source (2, 3; 33) consists of at least one light-emitting diode.

19. A device according to claim 2, characterised in that the imaging is performed when the container (5; 35; 65) is on a conveyor (6; 36; 66) installed in a reverse vending machine for beverage containers.

20. A device according to claim 3, characterised in that the imaging is performed when the container (5; 35; 65) is on a conveyor (6; 36; 66) installed in a reverse vending machine for beverage containers.

21. A device according to claim 2, characterised in that the processor comprises a comparator designed for recognition, based on the image selected by the processor, of the marking on the container (5; 35; 65) by comparing with a reference archive of markings and thus recognising distinctive features related to the container.

22. A device according to claim 3, characterised in that the processor comprises a comparator designed for recognition, based on the image selected by the processor, of the marking on the container (5; 35; 65) by comparing with a reference archive of markings and thus recognising distinctive features related to the container.
